(19) United States
(12) Patent Application Publication
(10) Pub. No.: US 2015/0280247 A1
(43) Pub. Date: Oct. 1, 2015

(54) PROCESS FOR PRODUCING A CARBON-SUPPORTED NICKEL-COBALT-OXIDE CATALYST AND ITS USE IN RECHARGEABLE ELECTROCHEMICAL METAL-OXYGEN CELLS

(71) Applicant: BASF SE, Ludwigshafen (DE)

(72) Inventors: Arnd Garsuch, Ludwigshafen (DE); Hubert Gasteiger, Muenchen (DE); Cueneyt Kavakli, Muenchen (DE); Gregor Harzer, Holzkirchen (DE)

(73) Assignee: BASF SE, Ludwigshafen (DE)

(21) Appl. No.: 14/441,689

(22) PCT Filed: Oct. 30, 2013
(86) PCT No.: PCT/IB2013/059781

§ 371 Date: May 8, 2015

Related U.S. Application Data
(60) Provisional application No. 61/724,311, filed on Nov. 9, 2012.

(51) Int. Cl. H01M 4/90; H01M 4/86; H01M 12/08

(52) U.S. Cl. CPC H01M 4/9083; H01M 12/08; H01M 4/8615; H01M 4/9016; H01M 2220/20

(57) ABSTRACT

The present invention relates to a process for producing carbon-supported nickel-cobalt-oxide catalysts, to carbon-supported nickel-cobalt-oxide catalysts obtainable or obtained by the process according to the invention, to gas diffusion electrodes comprising said carbon-supported nickel-cobalt-oxide catalysts and to electrochemical cells comprising said gas diffusion electrodes.

The present invention relates to a process for producing carbon-supported nickel-cobalt-oxide catalysts, to carbon-supported nickel-cobalt-oxide catalysts obtainable or obtained by the process according to the invention, to gas diffusion electrodes comprising said carbon-supported nickel-cobalt-oxide catalysts and to electrochemical cells comprising said gas diffusion electrodes.

Secondary batteries, accumulators or “rechargeable batteries” are just some embodiments by which electrical energy can be stored after generation and used when required. Owing to the significantly better power density, there has in recent times been a move away from the water-based secondary batteries toward development of those batteries in which the charge transport in the electrical cell is accomplished by lithium ions.

However, the energy density of conventional lithium ion accumulators which have a carbon anode and a cathode based on metal oxides is limited. New horizons with regard to the energy density were opened up by lithium-sulfur cells and especially by lithium-oxygen or lithium-air cells. In a customary embodiment, a metal, especially lithium, is oxidized with atmospheric oxygen in a nonaqueous electrolyte to form an oxide or peroxide, i.e. in the case of lithium to form Li₂O or Li₂O₂. The energy released is utilized by an electrical device. Such batteries can be re-charged by reducing the metal ions formed in the course of discharge. It is known that gas diffusion electrodes (GDEs) can be used as the cathode for this purpose. Gas diffusion electrodes are porous and have bifunctional action. Metal-air batteries must enable the reduction of the atmospheric oxygen to oxide or peroxide ions in the course of discharging, and the oxidation of the oxide or peroxide ions to oxygen in the course of charging. For example, it is known that gas diffusion electrodes can be constructed on a carrier material composed of fine carbon which has one or more catalysts for catalysis of the oxygen reduction or oxygen evolution.

For example, A. Débart et al., Angew. Chem. 2008, 120, 4597 (Angew. Chem. Int. Ed. Engl. 2008, 47, 4521) discloses that catalysts are required for such gas diffusion electrodes. Débart et al. mention Co₂O₄, Fe₂O₃, CuO and CoFe₂O₄, and they give reports of α-MnO₂ nanowires and compare them with MnO₂, β-MnO₂, γ-MnO₂, λ-MnO₂, Mn₂O₃ and Mn₃O₄.

M. Guene et al., Bull. Chem. Soc. Ethiop., 2007, 21(2), 255-262 discloses four different routes for the preparation of nickel-cobalt spinel oxides NiₓCo₃₋ₓO₄. Electrical conductivity as well as porosity of the different nickel-cobalt spinel oxides has been investigated.

Y. Q. Wu et al., Electrochimica Acta, 56 (2010) 7517-7522 discloses a sol-gel approach for controllable synthesis of NiCo₂O₄ crystals and their use as electrode materials in supercapacitors.

H. Cheng et al., J. Power Sources 195 (2010)1370-1374 discloses carbon-supported manganese oxide nanocatalyst for rechargeable lithium-air batteries. Manganese oxide based catalysts were synthesized in the form of nano-particles using a redox reaction of MnSO₄ and KMnO₄, housed into the pores of a carbon matrix and followed by a thermal treatment.

L. Wang et al., J. Electrochem. Soc. 158, A1379-A1382 (2011) discloses the preparation of CoMn₂O₄ spinel nanoparticles grown on graphene as bifunctional catalyst for lithium-air batteries.

Proceeding from this prior art, the object was to find flexible and more efficient synthesis routes to catalysts and to find catalysts, which are improved with regard to at least one of the following properties: electric conductivity, electrocatalytic activity, resistance to chemicals, electrochemical corrosion resistance, mechanical stability, good adhesion on the carrier material and low interaction with binder, conductive black and/or electrolyte. In addition, optimization of the costs caused by material and production expenditure should be taken into account, in order to promote the proliferation of this new energy storage technology.

This object is achieved by a process for producing a carbon-supported nickel-cobalt-oxide catalyst comprising

(A) carbon in an electrically conductive polymorph and

(B) nickel-cobalt-oxide of formula (I)

NiₓCo₃₋ₓO₄ (I),
wherein x is in the range from 0.5 to 2.0, preferably in the range from 0.7 to 1.5, in particular in the range from 0.8 to 1.1

comprising the process steps of
(a) preparation of an aqueous suspension comprising
(A) carbon in an electrically conductive polymorph,
(B1) at least one Ni(II) salt,
(B2) at least one Co(II) salt and,
(C) at least one chelating ligand,
(b) evaporation of the solvents of the suspension, which was prepared in process step (a), in order to obtain a solid (S) comprising components (A), (B1), (B2) and (C), and
(c) calcination of solid (S) in the presence of oxygen in a temperature range from 250° C. to 350° C.

In process step (a) of the inventive process an aqueous suspension comprising carbon in an electrically conductive polymorph (A), at least one Ni(II) salt (B1), at least one Co(II) salt (B2) and at least one chelating ligand (C) is prepared.

Carbon in an electrically conductive polymorph (A) may, in the context of the present invention, also be referred to as carbon (A). Carbon (A) can be selected, for example, from graphite, carbon black, carbon nanotubes, graphene or mixtures of at least two of the aforementioned substances.

In one embodiment of the present invention, carbon (A) is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, carbon (A) is partially oxidized carbon black.

In one embodiment of the present invention, carbon (A) comprises carbon nanotubes. Carbon nanotubes (CNT for short), for example single-wall carbon nanotubes (SW CNTs) and preferably multiwall carbon nanotubes (MW CNTs), are known per se. A process for production thereof and some properties are described, for example, by A. Jess et al. in Chemie lngenieur Technik 2006, 78, 94-100.

Graphene in the context of the present invention is understood to mean almost ideally or ideally two-dimensional hexagonal carbon crystals which have an analogous structure to individual graphite layers.

In a preferred embodiment of the present invention, carbon (A) is selected from graphite, graphene, activated carbon and especially carbon black.

Carbon (A) may be present, for example, in particles which have a diameter in the range from 0.1 to 100 μm, preferably 2 to 20 μm. The particle diameter is understood to mean the mean diameter of the secondary particles, determined as the volume average.

In one embodiment of the present invention, carbon (A) and especially carbon black has a BET surface area in the range from 20 to 1500 m²/g, measured according to ISO 9277.

In one embodiment of the present invention, at least two, for example two or three, different kinds of carbon (A) are mixed. Different kinds of carbon (A) may differ, for example, with regard to particle diameter or BET surface area or degree of contamination.

In one embodiment of the present invention, the carbon (A) selected is a combination of carbon black and graphite.

In one embodiment of the present invention, the inventive process is characterized in that the carbon in an electrically conductive polymorph (A) is selected from carbon black.

The aqueous suspension, which is prepared in process step (a) comprises at least one Ni(II) salt (B1) and at least one Co(II) salt (B2). In process step (a) it is possible to use a single Ni(II) salt or a mixture of two or more Ni(II) salts and to combine it with a single Co(II) salt or a mixture of two or more Co(II) salts. In a preferred embodiment of the present invention the Ni(II) salts (B1) and the Co(II) salts (B2) are soluble in water, preferably each salt having a solubility of at least 0.1 mol/l, in particular at least 0.5 mol/l in water. Preferred water soluble Ni(II) salts (B1) are Ni(acetate)₂, Ni(NO₃)₂, NiSO₄ and the corresponding hydrates of these nickel salts. Preferred water soluble Co(II) salts (B2) are Co(acetate)₂, Co(NO₃)₂, CoSO₄ and the corresponding hydrates of these cobalt salts. In particular preferred are the acetates of nickel and cobalt.

In one embodiment of the present invention, the inventive process is characterized in that in process step (a) Ni(II) salt (B1) is selected from the group of salts consisting of Ni(acetate)₂, Ni(NO₃)₂, NiSO₄ and the corresponding hydrates of said Ni(II) salts, in particular Ni(acetate)₂, and Co(II) salt (B2) is selected from the group of salts consisting of Co(acetate)₂, Co(NO₃)₂, CoSO₄ and the corresponding hydrates of said Co(II) salts, in particular Co(acetate)₂.

The aqueous suspension, which is prepared in process step (a), comprises at least one chelating ligand (C), preferably a water soluble chelating ligand.

Chelating ligands, also called chelate ligands, chelating agents or polydentate ligands, possess two or more coordination sites for metal cations, and it is preferably possible in each case for two coordination sites of the chelating ligand, together with a metal cation, preferably a transition metal cation, to form a strain-free 5- or 6-membered ring. Such metal complexes are referred to as chelate complexes. In the chelate complex, the organic chelate ligand itself may be present as an uncharged constituent, for example 2,2′-bipyridine, or in singly or multiply deprotonated form, for example as oxinate or tartrate.

Examples of chelating ligands are acetylacetone, salicylimide, N,N′-ethylenebis(salicylimine), ethylenediamine, 2-(2-aminoethylamino)ethanol, diethylenetriamine, iminodiacetic, triethylene-tetramine, triaminotriethylamine, nitrilotriacetic acid, ethylenediaminotriacetic acid, ethylenediaminetetraacetic acid, diethylenetriaminepentaacetic acid, 1,4,7,10-tetraazacyclododecane-1,4,7,10-tetraacetic acid, oxalic acid, tartaric acid, citric acid, dimethylglyoxime, 8-hydroxyquinoline, dimercaptosuccinic acid, 2,2′-bipyridine or 1,10-phenanthroline.

In one embodiment of the present invention, the inventive process is characterized in that in process step (a) chelating ligand (C) is citric acid.

In process step (a) the molar ratio of the total amount of Ni(II) salts to the total amount of Co(II) salts can be varied in wide range. Preferably a molar ratio of the total amount of Ni(II) salts to the total amount of Co(II) salts is chosen in the range from 0.2 to 2, preferably in the range from 0.3 to 1, in particular in the range from 0.35 to 0.6.

In one embodiment of the present invention, the inventive process is characterized in that in process step (a) the molar ratio of the total amount of Ni(II) salts to the total amount of Co(II)salts is x/(3-x) wherein x is in the range from 0.5 to 2.0, preferably in the range from 0.7 to 1.5, in particular in the range from 0.8 to 1.1.

In process step (a) the molar ratio of the total amount of chelating ligand (C) to the sum of the total amount of Ni(II) salts and Co(II) salts can be varied in wide range. Preferably a molar ratio of the total amount of chelating ligand (C) to the sum of the total amount of Ni(II) salts and Co(II) salts is in the range from 0.1 to 10, preferably in the range from 0.5 to 5, in particular in the range from 1 to 3.

The aqueous suspension prepared in reaction step (a) may comprise in addition to water additional solvents. Preferably the aqueous suspension comprises at least one organic polar solvent, in particular an organic polar solvent, that is completely miscible with water. A particularly preferred organic polar solvent is selected from the group of solvents consisting of tetrahydrofuran, iso-propanol, n-propanol, ethanol, methanol, ethylene glycol, dimethyl sulfoxide, dimethylformamide, acetonitrile, acetone, acetic acid and propionic acid, in particular selected from the group of solvents consisting of iso-propanol, n-propanol and ethanol.

In one embodiment of the present invention, the inventive process is characterized in that the aqueous suspension of process step (a) comprises at least one organic polar solvent, most preferably iso-propanol.

In the aqueous suspension prepared in process step (a) the ratio of the volume of water to the volume of the organic polar solvents which are mixed together can be varied in a wide range. Preferably the ratio of the volume of water to the volume of the organic polar solvents is in the range from 0.1 to 10, preferably in the range from 0.3 to 3, in particular in the range from 0.5 to 2.

In the aqueous suspension prepared in process step (a) the sum of the fractions of water and the organic polar solvents, that are completely miscible with water, together is at least 80% by volume, preferably at least 90% by volume, in particular in the range from 95% to 100% by volume.

The components of the aqueous suspension can in principle be combined in manifold manner. Preferably the nickel and cobalt salts (B1) and (B2) are dissolved together with the chelating ligand (C) in pure water. Preferably carbon (A) is the last component which is mixed with all other components (B1), (B2) and (C) of the suspension.

In one embodiment of the present invention, the inventive process is characterized in that in process step (a) an aqueous solution comprising the components (B1), (B2) and (C) is mixed with carbon (A), in particular carbon in pulverous form.

In a preferred embodiment of the present invention at least on organic polar solvent as described above is added to a solution of (B1), (B2) and (C) in water and the formed liquid mixture is subsequently combined with carbon (A) in powder form in order to produce the aqueous suspension in process step (a), in particular by pouring the solution to carbon (A).

The preparation of an aqueous suspension process step (a) can take place in a wide temperature range. Depending on the freezing point and boiling point of the solvent or mixture of solvents used to dissolve the salts (B1) and (B2) and the chelating ligand (C) and to suspend carbon (A) a temperature can be chosen. Process step (a) is preferably carried out in a temperature range between 0° C. and 100° C., particularly preferably in a temperature range from 10° C. to 40° C., especially at room temperature.

In a particularly preferred embodiment of the present invention the inventive process is characterized in that in process step (a) an aqueous suspension comprising
(A) carbon black,
(B1) Ni(acetate)₂,
(B2) Co(acetate)₂,
(C) citric acid,
water and isopropanol is prepared by following steps:
(aa) forming a solution of 1 equivalent (B1) with 1.6 to 2.8, preferably 1.9 to 2.2 equivalents (B2) and 2 to 10, preferably 6 to 7 equivalents (C) in water, wherein the concentration of (B1) is in the range from 0.01 to 1 mol/l, preferably in the range from 0.05 to 0.2 mol/l,
(bb) mixing iso-propanol with the solution formed in step (aa), wherein the ratio of the volume of iso-propanol to the volume of water is in the range from 0.5 to 2, preferably in the range from 0.8 to 1.2, and
(cc) adding the liquid mixture produced in step (bb) to carbon black in pulverous form in order to form the aqueous suspension of process step (a), in particular with the aid of a mixer or an ultrasonic homogenizer.

In process step (b) the solvents of the suspension, which was prepared in process step (a), are evaporated in order to obtain a solid (S) comprising components (A), (B1), (B2) and (C).

The evaporation of the solvents of the suspension can take place in a wide temperature range. In order to reduce the temperature and in order to reduce the time for evaporating the solvents, reduced pressure can be applied. Preferably the solvents, in particular water and the organic polar solvent or solvents, are evaporated at a temperature in the range from 20° C. to 150° C. optionally under reduced pressure, especially under a constant gas flow. The temperature can be kept constant or can be changed during the evaporation step. Several technics are known to evaporate solvents from a suspension. The suspension can be poured into petri dishes or beakers, which are preferably placed in a vacuum oven in order to remove the solvents. Another possibility is the use of a rotary evaporator in combination with a vacuum pump.

In one embodiment of the present invention, the inventive process is characterized in that process step (b) takes place at a temperature in the range from 20° C. to 150° C. optionally under reduced pressure.

The solid (S) obtained in process step (b) can still contain some solvent or solvents even though solid (S) is a powder.

In process step (c) solid (S) is calcinated in the presence of oxygen in a temperature range from 250° C. to 350° C., preferably from 290° C. to 330° C., in particular from 295° C. to 325° C.

In process step (c) residual solvents are removed and the combination of nickel and cobalt salts is converted in the presence of oxygen to nickel-cobalt-oxide of formula (I), preferably in crystalline form. Chelating ligand (C) is either evaporated or decomposed under the reaction conditions. Preferably the anions of the nickel and cobalt salts are also removed by decomposition under the reaction conditions.

In process step (c) the oxygen, in particular molecular oxygen (O₂) can be used in dilute form, for example as air, or in highly concentrated form. Preferably air is used as source of oxygen.

In one embodiment of the present invention, the inventive process is characterized in that process step (c) takes place at a temperature in the range from 295° C. to 325° C.

The present invention further also provides a carbon-supported nickel-cobalt-oxide catalyst comprising

(A) carbon in an electrically conductive polymorph and

(B) nickel-cobalt-oxide of formula (I)

NiₓCo₃₋ₓO₄ (I),
wherein x is in the range from 0.5 to 2.0, preferably in the range from 0.7 to 1.5, in particular in the range from 0.8 to 1.1,

obtainable by a process for producing a carbon-supported nickel-cobalt-oxide catalyst as described above. This process comprises the above-described process steps a), b) and c), especially also with regard to preferred embodiments thereof.

The present invention likewise also provides a carbon-supported nickel-cobalt-oxide catalyst comprising

(A) carbon in an electrically conductive polymorph and

(B) nickel-cobalt-oxide of formula (I)

NiₓCo₃₋ₓO₄ (I),
wherein x is in the range from 0.5 to 2.0, preferably in the range from 0.7 to 1.5, in particular in the range from 0.8 to 1.1,

wherein the catalyst is prepared by a process comprising the process steps of

(a) preparation of an aqueous suspension comprising
(A) carbon in an electrically conductive polymorph,
(B1) at least one Ni(II) salt,
(B2) at least one Co(II) salt and,
(C) at least one chelating ligand,
(b) evaporation of the solvents of the suspension, which was prepared in process step (a), in order to obtain a solid (S) comprising components (A), (B1), (B2) and (C), and
(c) calcination of solid (S) in the presence of oxygen in a temperature range from 250° C. to 350° C.

The process steps a), b) and c) have been described above. In particular, preferred embodiments of the process steps have been described above.

The carbon-supported nickel-cobalt-oxide catalyst, also called catalyst (AB) for short hereinafter, which is obtainable or obtained by the inventive process, comprises as component (A) carbon (A) in an electrically conductive polymorph and as component (B) nickel-cobalt-oxide of the formula NiₓCo₃₋ₓO₄, wherein x is in the range from 0.5 to 2.0, preferably in the range from 0.7 to 1.5, in particular in the range from 0.8 to 1.1.

Carbon (A), which has been described above in detail, is the support of nickel-cobalt-oxide of the formula NiₓCo₃₋ₓO₄, which is formed in process step (c).

Nickel-cobalt-oxide of the formula NiₓCo₃₋ₓO₄, wherein x is in the range from 0.5 to 2.0, preferably in the range from 0.7 to 1.5, in particular in the range from 0.8 to 1.1, also called nickel-cobalt-oxide (B) for short hereinafter, is existent in the form of nano-particles, which are uniformly distributed over the carbon support.

In one embodiment of the present invention the average particle size of the nickel-cobalt-oxide (B) of formula NiₓCo₃₋ₓO₄, wherein x is in the range from 0.5 to 2.0, preferably in the range from 0.7 to 1.5, in particular in the range from 0.8 to 1.1, is in the range from 1 nm to 30 μm, preferably in the range from 2 nm to 1 μm, particularly preferred in the range from 5 nm to 20 nm.

In one embodiment of the present invention the nickel-cobalt-oxide (B) has spinel structure.

In the carbon-supported nickel-cobalt-oxide catalyst (AB) according to the invention, the sum of the fractions of carbon (A) and nickel-cobalt-oxide (B) comprising spinel structure together is preferably at least 90% by weight, particular preferably at least 95% by weight, in particular in the range from 98% to 100% by weight.

In one embodiment of the present invention the carbon-supported nickel-cobalt-oxide catalyst (AB) comprises between 0 and 5% by weight, preferably between 0 and 1% by weight, in particular between 0 and 0.2% by weight, based on the total mass of the carbon-supported nickel-cobalt-oxide catalyst, NiO.

The structure of the crystals formed in the calcination step (c) and the portion of different crystal phases, like the portion of the desired spinel structure of NiₓCo₃₋ₓO₄ (B) and the portion of of the undesirable NiO is determined by powder X-ray diffraction.

The ratio between nickel-cobalt-oxide (B) and carbon (A) can be varied in a wide range. Preferably the ratio by weight between nickel-cobalt-oxide (B) and carbon (A) is in the range from 1 to 100 to 10 to 1, particularly preferably in the range from 1 to 20 to 2 to 1, especially in the range from 1 to 4 to 1 to 1.

Carbon-supported nickel-cobalt-oxide catalyst (AB) may be present, for example, in particles which have a diameter in the range from 0.1 to 100 μm, preferably 0.3 to 10 μm. The particle diameter is understood to mean the mean diameter of the secondary particles, determined as the volume average. The particles size can be determined according to Transmission Electron Microscopy (TEM) measurement.

In one embodiment of the present invention, carbon-supported nickel-cobalt-oxide catalyst (AB) has a BET surface area in the range from 15 to 2000 m²/g, preferably from 50 to 400 m²/g, in particular from 100 to 250 m²/g, measured according to ISO 9277.

In a particularly preferred embodiment of the present invention the inventive carbon-supported nickel-cobalt-oxide catalyst (AB) comprises carbon black as carbon (A) and nickel-cobalt-oxide (B) of formula (I) NiₓCo₃₋ₓO₄ in spinel structure, wherein x is in the range from 0.8 to 1.1, and wherein nickel-cobalt-oxide (B) is existent in the form of nano-particles, which are uniformly distributed over carbon (A), wherein the average particle size of the nickel-cobalt-oxide nano-particles is in the range from 5 nm to 20 nm, and wherein the sum of the fractions of carbon (A) and nickel-cobalt-oxide (B) together is in the range from 98% to 100% by weight.

The inventive carbon-supported nickel-cobalt-oxide catalyst (AB), which is obtainable or obtained by the above described inventive process is particularly suitable as a cathode active material for gas diffusion electrodes of an electrochemical cell, in particular of a rechargeable electrochemical cell like a metal-air or metal-oxygen cell. In addition to carbon-supported nickel-cobalt-oxide catalyst (AB) a gas diffusion electrode comprises at least one solid medium through which gas can diffuse and which optionally serves as a carrier for the carbon-supported nickel-cobalt-oxide catalyst (AB). In addition, the inventive gas diffusion electrode may comprise additional carbon in an electrically conductive polymorph and at least one binder.

The present invention further provides a gas diffusion electrode comprising the inventive carbon-supported nickel-cobalt-oxide catalyst (AB) as described above and at least one solid medium through which gas can diffuse and which optionally serves as a carrier for the carbon-supported nickel-cobalt-oxide catalyst.

The inventive gas diffusion electrode comprises, as well as the inventive carbon-supported nickel-cobalt-oxide catalyst (AB), at least one solid medium, also called medium (M) for short in the context of the present invention, through which gas can diffuse or which optionally serves as a carrier for the inventive carbon-supported nickel-cobalt-oxide catalyst (AB).

Media (M) in the context of the present invention are preferably those porous bodies through which oxygen or air can diffuse even without application of elevated pressure, for example metal meshes and gas diffusion media composed of carbon, especially activated carbon, and also carbon on metal mesh.

In one embodiment of the present invention, air or atmospheric oxygen can flow essentially unhindered through medium (M).

In one embodiment of the present invention, medium (M) is a medium which conducts electrical current.

In a preferred embodiment of the present invention, medium (M) is chemically inert toward the reactions which proceed in an electrochemical cell in standard operation, i.e. in the course of charging and in the course of discharging.

In one embodiment of the present invention, medium (M) has an internal BET surface area in the range from 0.1 to 1500 m²/g, which is preferably determined as the apparent BET surface area.

In one embodiment of the present invention, medium (M) is selected from metal meshes, for example nickel meshes or tantalum meshes. Metal meshes may be coarse or fine.

In another embodiment of the present invention, medium (M) is selected from electrically conductive fabrics, for example mats, felts or nonwovens composed of carbon, which comprise metal filaments, for example tantalum filaments or nickel filaments.

In one embodiment of the present invention, medium (M) is selected from gas diffusion media, for example activated carbon, aluminum-doped zinc oxide, antimony-doped tin oxide or porous carbides or nitrides, for example WC, Mo₂C, Mo₂N, TiN, ZrN or TaC.

In addition, it is possible to apply the inventive carbon-supported nickel-cobalt-oxide catalyst (AB) in the form of a liquid formulation preferably together with additional carbon in an electrically conductive polymorph and/or a binder and a suitable solvent or solvent mixture, as described below, to a medium (M), which is an electrically insulating flat material which can typically be used as a separator in electrochemical cells and is described in detail below.

The gas diffusion electrode comprises preferably in addition to carbon-supported nickel-cobalt-oxide catalyst (AB) and medium (M) additional carbon in an electrically conductive polymorph and/or at least one binder, also called binder (aa) for short in the context of the present invention.

The additional carbon in an electrically conductive polymorph, also called carbon (A2) for short in the context of the present invention is defined in the same manner as carbon (A). Carbon

(A2), the additonal carbon, can be identical to or different from carbon (A), which was used in the process for producing carbon-supported nickel-cobalt-oxide catalyst (AB). Preferred forms of carbon (A2) are carbon black or graphite or mixtures thereof.

The binder (aa) is typically an organic polymer. Binder (aa) serves principally for mechanical stabilization of carbon-supported nickel-cobalt-oxide catalyst (AB), by virtue of carbon-supported nickel-cobalt-oxide catalyst (AB) particles and optionally carbon (A2) particles being bonded to one another by the binder, and also has the effect that the carbon-supported nickel-cobalt-oxide catalyst (AB) has sufficient adhesion to an output conductor. The binder (aa) is preferably chemically inert toward the chemicals with which it comes into contact in an electro-chemical cell.

In one embodiment of the present invention, binder (aa) is selected from organic (co)polymers. Examples of suitable organic (co)polymers may be halogenated or halogen-free. Examples are polyethylene oxide (PEO), cellulose, carboxymethylcellulose, polyvinyl alcohol, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene. Of particular suitability are tetrafluoroethylene polymer, or sulfonated tetrafluoroethylene polymer exchanged with lithium ions, which is also referred to as Li-exchanged Nafion®.

The mean molecular weight M_{w} of binder (aa) may be selected within wide limits, suitable examples being 20 000 g/mol to 1 000 000 g/mol.

In one embodiment of the present invention, the gas diffusion electrode comprises in the range from 10 to 60% by weight of binder (aa), preferably 20 to 45% by weight and more preferably 30 to 35% by weight, based on the total mass of carbon-supported nickel-cobalt-oxide catalyst (AB), carbon (A2) and binder (aa).

Binder (aa) can be combined with carbon-supported nickel-cobalt-oxide catalyst (AB) and carbon (A2) by various processes. For example, it is possible to dissolve a soluble binder (aa) such as polyvinyl alcohol in a suitable solvent or solvent mixture, for example in water/isopropanol, and to prepare a suspension with carbon-supported nickel-cobalt-oxide catalyst (AB) and carbon (A2). After application of the suspension to a suitable medium (M), the solvent or solvent mixture is removed, for example evaporated, to obtain an inventive gas diffusion electrode. A suitable solvent for polyvinylidene fluoride is NMP. The application can be accomplished, for example, by spraying, for example spray application or atomization, and also knifecoating, printing or by pressing. In the context of the present invention, atomization also includes application with the aid of a spray gun, a process frequently also referred to as “airbrush method” or “air-brushing” for short.

If it is desirable to use sparingly soluble polymers as binder (aa), for example polytetrafluoroethylene, tetrafluoroethylene-hexafluoropropylene copolymers or Li-exchanged Nafion®, a suspension of particles of the relevant binder (aa), carbon-supported nickel-cobalt-oxide catalyst (AB), and also further possible constituents of the gas diffusion electrode like carbon (A2), is prepared and processed as described above to give a gas diffusion electrode.

In addition, the gas diffusion electrode may have further constituents customary per se, for example an output conductor, which may be configured in the form of a metal wire, metal grid, metal mesh, expanded metal, metal sheet or metal foil, stainless steel being particularly suitable as the metal.

Further components of gas diffusion electrode may, for example, also be solvents, which are understood to mean organic solvents, especially isopropanol, N-methylpyrrolidone, N,N-dimethylacetamide, amyl alcohol, n-propanol or cyclohexanone. Further suitable solvents are organic carbonates, cyclic or noncyclic, for example diethyl carbonate, ethylene carbonate, propylene carbonate, dimethyl carbonate and ethyl methyl carbonate, and also organic esters, cyclic or noncyclic, for example methyl formate, ethyl acetate or γ-butyrolactone (gamma-butyrolactone), and also ethers, cyclic or noncyclic, for example 1,3-dioxolane.

In addition, the gas diffusion electrode may comprise water.

In one embodiment of the present invention, gas diffusion electrode has a thickness in the range from 5 to 250 μm, preferably from 10 to 100 μm, based on the thickness without output conductor.

The gas diffusion electrode may be configured in various forms, for example in rod form, in the form of round, elliptical or square columns, or in cuboidal form, especially also as a flat electrode. For instance, it is possible, in the case that medium (M) is selected from metal meshes, that the shape of the gas diffusion electrode is essentially defined by the shape of the metal grid.

In one embodiment of the present invention, a composition, which comprises the inventive carbon-supported nickel-cobalt-oxide catalyst (AB), a binder (aa) and optionally carbon (A2), due to its structure, is already self-supporting and gas-pervious, and so it is unnecessary to use a medium (M) as support material, which is permeable to gas.

The present invention further provides for the use of inventive gas diffusion electrodes for production of electrochemical cells, for example for production of non-rechargeable electrochemical cells, which are also referred to as primary batteries, or for production of rechargeable electrochemical cells, which are also referred to as secondary batteries. The present invention further provides an electrochemical cell, preferably a rechargeable electrochemical cell comprising at least one inventive gas diffusion electrode as described above.

In the inventive electrochemical cell, in particular in the rechargeable electrochemical cell, in the course of the discharging operation thereof, a gas is reduced at the gas diffusion electrode, especially molecular oxygen O₂. Molecular oxygen O₂ can be used in dilute form, for example in air, or in highly concentrated form.

Inventive electrochemical cells, in particular rechargeable electrochemical cells further comprise at least one anode, which comprises metallic magnesium, metallic aluminum, metallic zinc, metallic sodium or metallic lithium. The anode preferably comprises metallic lithium. Lithium may be present in the form of pure lithium or in the form of a lithium alloy, for example lithium-tin alloy or lithium-silicon alloy or lithium-tin-silicon alloy.

In a further embodiment of the present invention, the inventive electrochemical cell is a lithium-oxygen cell, for example a lithium-air cell.

In one embodiment of the present invention, inventive electrochemical cells comprise one or more separators by which gas diffusion electrode and anode are mechanically separated from one another. Suitable separators are polymer films, especially porous polymer films, which are unreactive toward metallic lithium, the reaction products formed at the gas diffusion electrode in the discharging operation, and toward the electrolyte in the inventive electrochemical cells. Particularly suitable materials for separators are polyolefins, especially porous polyethylene films and porous polypropylene films.

Polyolefin separators, especially of polyethylene or polypropylene, may have a porosity in the range from 35 to 45%. Suitable pore diameters are, for example, in the range from 30 to 500 nm.

In another embodiment of the present invention, the separators selected may be separators composed of PET nonwovens filled with inorganic particles. Such separators may have a porosity in the range from 40 to 55%. Suitable pore diameters are, for example, in the range from 80 to 750 nm.

Additionally suitable is glass fiber-reinforced paper or inorganic nonwovens, such as glass fiber nonwovens or ceramic nonwovens.

The procedure for production of the inventive electrochemical cells may be, for example, to combine gas diffusion electrode, anode and optionally one or more separators with one another in accordance with the invention and to introduce them into a housing together with any further components. The electrodes, i.e. gas diffusion electrode or anode, may, for example, have thicknesses in the range from 20 to 500 μm, preferably 40 to 200 μm. They may, for example, be in the form of rods, in the form of round, elliptical or square columns, or in cuboidal form, or in the form of flat electrodes.

In a further embodiment of the present invention, above-described inventive electrochemical cells comprise, as well as the electrodes, a liquid electrolyte comprising a conductive salt, in particular a lithium-containing conductive salt.

In one embodiment of the present invention, inventive electrochemical cells comprise, as well as the gas diffusion electrode and the anode, especially an anode comprising metallic lithium, at least one nonaqueous solvent which may be liquid or solid at room temperature, and is preferably liquid at room temperature, and which is preferably selected from polymers, cyclic and noncyclic ethers, cyclic and noncyclic acetals, cyclic and noncyclic organic carbonates and ionic liquids.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

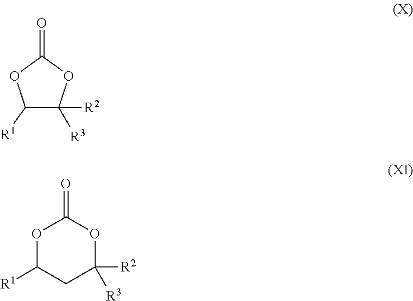

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

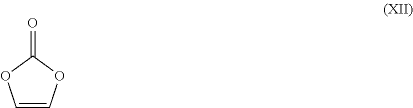

Further preferred solvents are also the fluorinated derivates of the aforementioned solvents, especially fluorinated derivatives of cyclic or noncyclic ethers, cyclic or noncyclic acetals or cyclic or noncyclic organic carbonates, in each of which one or more hydrogen atoms have been replaced by fluorine atoms.

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,

m=2 when X is selected from nitrogen and phosphorus, and

m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

Examples of suitable solvents are especially propylene carbonate, ethylene carbonate, ethyl methyl carbonate, diethyl carbonate and mixtures of at least two of the aforementioned solvents, especially mixtures of ethylene carbonate with ethyl methyl carbonate or diethyl carbonate.

In one embodiment of the present invention, inventive electrochemical cells may comprise a further electrode, for example as a reference electrode. Suitable further electrodes are, for example, lithium wires.

Inventive electrochemical cells give a high voltage and are notable for a high energy density and good stability. More particularly, inventive electrochemical cells are notable for an improved cycling stability.

The inventive electrochemical cells can be assembled to metal-air batteries, preferably rechargeable metal-air batteries, especially to rechargeable lithium-air batteries.

Accordingly, the present invention also further provides for the use of inventive electrochemical cells as described above in rechargeable metal-air batteries, especially rechargeable lithium-air batteries.

The present invention further provides rechargeable metal-air batteries, especially rechargeable lithium-air batteries, comprising at least one inventive electrochemical cell as described above. Inventive electrochemical cells can be combined with one another in inventive rechargeable metal-air batteries, especially in rechargeable lithium-air batteries, for example in series connection or in parallel connection. Series connection is preferred.

Inventive electrochemical cells are notable for particularly high capacities, high performances even after repeated charging and greatly retarded cell death. Inventive electrochemical cells are very suitable for use in motor vehicles, bicycles operated by electric motor, for example pedelecs, aircraft, ships or stationary energy stores. Such uses form a further part of the subject matter of the present invention.

The present invention further provides for the use of inventive electrochemical cells as described above in motor vehicles, bicycles operated by electric motor, aircraft, ships or stationary energy stores.

The use of inventive rechargeable metal-air batteries, especially rechargeable lithium-air batteries, in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The present invention therefore also further provides for the use of inventive rechargeable metal-air batteries, especially rechargeable lithium-air batteries, in devices, especially in mobile devices. Examples of mobile devices are vehicles, for example motor vehicles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The present invention further provides a device comprising at least one inventive electrochemical cell as described above.

The invention is illustrated by the examples which follow but do not restrict the invention.

Figures in percent are each based on % by weight, unless explicitly stated otherwise.

The existence of the phases of all composites were proved and determined by Transmission Electron Microscopy (JEOL JEM-100CX) and powder X-ray diffraction which is obtained by using Philips X'pert PRO diffractometer with Cu Kα X-ray radiation (1.54 Å). The elemental compositions of the materials were determined by CHNS analyzer, Energy-dispersive X-ray spectroscopy (JEOL JSM-5900LV) and atomic absorption spectroscopy (VARIAN). Thermogravimetric (TGA) and calorimetric (DSC) analyses were performed on a Mettler Toledo TGA/DSC 1 instrument coupled to a Pfeiffer Vacuum Thermostar mass spectrometer for evolved gas analysis (EGA). Nitrogen-sorption porosimetry (Quantachrome autosorb iQ) was used to define the surface area of the materials and calculated from the adsorption branch of nitrogen physisorption isotherms according to the multipoint BET method.

I. Preparation of carbon-supported nickel-cobalt-oxide catalysts

I.1 Synthesis of Catalyst-1

2.08 mmol Ni(OCOCH₃)₂.4H₂O, 4.16 mmol Co(OCOCH₃)₂.4H₂O and 12.3 mmol citric acid were well dissolved in 20 ml of water and in to this solution, 20 ml of isopropanol were added. The mixture was then poured into a beaker containing 2 g of carbon black (Vulcan XC-72; N₂ BET surface area: 240 m²/g_{carbon}; primary particle size: 30 nm) and sonicated by using prope sonicator for 5 minutes. The suspension was dried on a large surface petri disk at 60° C. and then at 70° C. in a vacuum oven. The dried precursor, called “Precursor 1”, was collected, pulverized and a fraction of it, about half of it, was heat treated in an air circulating oven at 320° C. for 3 h. This calcinated material is called “Catalyst 1”.

I.1.a Characterization of Catalyst-1

XRD clearly indicates the formation of cubic spinel phase of NiₓCo₃₋ₓO₄ on carbon black. According to the Scherrer equation the average crystallite size of the formed NiₓCo₃₋ₓO₄ is 6.3 nm.

Results of the EDX analysis:

Carbon: 73.01%,

Oxygen: 11.93%,

Cobalt: 9.50%,

Nickel: 4.55%

Silicon: 0.48%

Sulfur: 0.53%

The specific surface area of the composite material based on the adsorption branch of nitrogen physisorption isotherms is 143 m²/gₘₐₜₑᵣᵢₐₗ.

The morphology and the distribution of NiₓCo₃₋ₓO₄ on the carbon were analyzed by TEM. Uniformly distributed NiₓCo₃₋ₓO₄ nano particles over the carbon are observed with crystal sizes between 6 and 12 nm; no obvious agglomeration of NiₓCo₃₋ₓO₄ is seen.

I.2 Synthesis of Catalyst-2

The second half of “Precursor 1), prepared in example I.1 was calcined in a tubular furnace at 300±3° C. for 2 h 30 min under 400 ml of synthetic air flow condition. The obtained material is called “Catalyst-2”.

I.2.a Characterization of Catalyst-2

XRD clearly indicates the formation of cubic spinel phase of NiₓCo₃₋ₓO₄ on carbon black. According to the Scherrer equation the average crystallite size of the formed NiₓCo₃₋ₓO₄ is 7.4 nm. XRD shows small amounts of NiO.

I.3 Synthesis of Catalyst-3

In another attempt, a suspension which was prepared in the same way as described in example I.1 was dried on a Celgard® 2500 separator in order to remove the difficulties during the collection of the dried precursor from the petri-disk, since in example I.1 the dried precursor can only be obtained by scratching the petri-disk with a spatula, which is time consuming and results in low-yield. The dried precursor, which was removed easily from the separator membrane, is called “Precursor 2”. 3 equal fractions of Precursor 2 were calcined in a tubular furnace at three different temperatures (295±5° C., 321±2° C. and 357±3° C.) each time under 400 ml/min of synthetic air flow condition for 2.5 h in order to obtain “Catalyst-3a”, “Catalyst-3b” and “Catalyst-3c”.

I.3.a Characterization of Catalyst-3a, Catalyst-3b and Catalyst-3c

For all samples XRD clearly indicates the formation of cubic spinel phase of NiₓCo₃₋ₓO₄ on carbon black. The amount of NiO decomposition product increases as the temperature increases.

Catalyst-3a, calcined at 295±5° C., is more or less pure NiₓCo₃₋ₓO₄.

Catalyst-3c, calcined at 357±3° C., shows NiO in significant amount.

II. Electrochemical testing of carbon-supported nickel-cobalt-oxide catalysts

In order to demonstrate the activity of carbon-supported nickel-cobalt-oxide catalysts for H₂O₂ electrooxidation, experiments with a rotating ring disk electrode (RRDE) were performed in a 0.1 M solution of KOH saturated in O₂ and containing 1.2 mM of H₂O₂. The electrode rotation was 1600 rpm and the sweep rate was 20 mV s⁻¹.

Both carbon-supported NiₓCo₃₋ₓO₄ (Catalyst-1 and Catalyst-2) catalysts present resembling H₂O₂-oxidation capabilities and are unequivocally much more active than carbon black (Vulcan XC-72) alone. At a relatively low potential of ≈1.0 VRHE (at which H₂O₂-electrooxidation is mostly kinetically controlled) the following current density were measured:

| | 1.0 V_{RHE} | 1.45 V_{RHE} |
|---|---|---|
| Catalyst-1: | 1.17 mA/cm²_{disk} | 1.95 mA/cm²_{disk} |
| Catalyst-2: | 1.08 mA/cm²_{disk} | 1.95 mA/cm²_{disk} |
| Vulcan XC-72 alone | 0.00 mA/cm²_{disk} | 0.53 mA/cm²_{disk} |

To investigate whether the NiₓCo₃₋ₓO₄ based catalysts can improve the rechargeability of Li—O₂ cells, Li₂O₂ electrochemical decomposition activity of Catalyst-1 was tested and compared with the activity of carbon black Vulcan XC-72.

Preparation of an electrode comprising Catalyst-1 (E-1)

A mixture of Catalyst-1 and Li₂O₂ (Li202/carbon ratio 1:1 wt.:wt.) (example 1.1) was added to a 0.67% wt. PEO 400K (Aldrich) solution in toluene (99.5%, <1 ppm water), wherein the ratio by weight of the binder PEO 400K to the carbon support (Vulcan XC-72) of Catalyst-1 is 0.2. The mixture was sonicated under Ar atmosphere for 10 minutes using a Branson 250 digital probe-sonifier. The ink obtained was coated directly on Celgard® C480 using a Meyer-Rod. After evaporation of the solvent at room temperature, 15 mm diameter cathode electrodes were punched out. The electrodes were dried under dynamic vacuum overnight at 50° C. in a glass oven (Buchi, Switzerland) and directly transferred for cell assembly into an argon-filled glove box (O₂<1 ppm, H₂O<1 ppm; Jacomex, France) without any exposure to ambient air.

Preparation of an electrode comprising only carbon black and no nickel-cobalt oxide (CE-2)

A 1:1 (wt.:wt.) mixture of Li₂O₂ and Vulcan XC-72 was added to a 0.67% wt. PEO 400K (Aldrich) solution in toluene (99.5%, <1 ppm water), wherein the ratio by weight of the binder PEO 400K to Vulcan XC-72 is 0.2. The mixture was sonicated under Ar atmosphere for 10 minutes using a Branson 250 digital probe-sonifier. The ink obtained was coated directly on Celgard® C480 using a Meyer-Rod. After evaporation of the solvent at room temperature, 15 mm diameter cathode electrodes were punched out. The electrodes were dried under dynamic vacuum overnight at 50° C. in a glass oven (Buchi, Switzerland) and directly transferred for cell assembly into an argon-filled glove box (O₂<1 ppm, H₂O<1 ppm; Jacomex, France) without any exposure to ambient air.

Assembly and operation of electrochemical test cells

The electrolyte used was 0.2 M LiTFSI (Sigma-Aldrich, 99.99%) in diglyme (anhydrous, Aldrich, 99.5%) The water content of the electrolyte was below 8 ppm (by Karl Fischer titration). The cells were constructed in an Ar-filled glovebox (O₂<1 ppm, H₂O<1 ppm). Cells were built and used as shown and described in Electrochemical and Solid-State Letters, 15 (4) A45 (2012). A 17 mm lithium disk (0.45 μm thick, 99.9%; Chemetall, Germany) was used as the anode, and 40 μl of electrolyte were applied to the lithium foil. Subsequently, 2 plies of Celgard® C480 separator were placed on and further 40 μl of electrolyte were added to the separators. Subsequently, the cathode (first cell: electrode E-1; second cell; electrode CE-2) was placed on and further 40 μl of electrolyte were added. 21 mm stainless steel (316SS) mesh (0.22 mm wire, 1.0 mm openings, Spörl KG,Germany) was also used as an output conductor on the cathode side. The cells were sealed with four screws at a torque of 6 Nm and charged galvanostatically at 120 mA/g_{carbon} using a VMP3 multi-potentiostat (Biologic, France).

The electrochemical cell comprising the electrode (E-1) comprising Catalyst-1 is charged at an average voltage of 3.94 V_{Li}, i.e. around 300 mV lower than the average voltage of 4.24 V_{Li} for charging the comparative electrochemical cell comprising electrode (CE-2) comprising no nickel-cobalt oxide.

1. A process for producing a carbon-supported nickel-cobalt-oxide catalyst comprising
(A) carbon in an electrically conductive polymorph, and
(B) a nickel-cobalt-oxide of formula (I):
NiₓCo₃₋ₓO₄ (I),
wherein x is in the range from 0.5 to 2.0.
the process comprising:
evaporating solvents contained in (a) preparation of an aqueous suspension comprising
(A) carbon in an electrically conductive polymorph,
(B1) a at 1 st one Ni(II) salt,
(B2) a at 1 st one Co(II) salt and
(C) a at least one chelating ligand,
to obtain a solid (S) comprising the components (A), (B1), (B2) and (C); and
calcinating the solid (S) in the presence of oxygen in a temperature range from 250° C. to 350° C., to form a carbon-supporting nickel-cobalt-oxide catalyst.

2. The process according to claim 1, wherein the carbon in an electrically conductive polymorph is a carbon black.

3. The process according to claim 1, wherein:
the Ni(II) salt (B1) is selected from the group consisting of Ni(acetate)₂, Ni(NO₃)₂, NiSO₄ and a hydrate thereof;
the Co(II) salt (B2) is selected from the group consisting of Co(acetate)₂, Co(NO₃)₂, CoSO₄ and a hydrate thereof.

4. The process according to claim 1, wherein the chelating ligand (C) is citric acid.

5. The process according to claim 1, wherein the aqueous suspension further comprises an organic polar solvent.

6. The process according to claim 1, further comprising mixing an aqueous solution comprising the Ni(II) salt, the Co(II) salt and the chelating ligand with the carbon (A) to form the aqueous suspension.

7. The process according to claim 1, wherein the evaporating occurs at a temperature in the range from 20° C. to 150° C.

8. The process according to claim 1, wherein the calcinating occurs at a temperature in the range from 295° C. to 325° C.

9. A carbon-supported nickel-cobalt-oxide catalyst comprising
(A) carbon in an electrically conductive polymorph and
(B) a nickel-cobalt-oxide of formula (I):
NiₓCo₃₋ₓO₄ (I),
wherein x is in the range from 0.5 to 2.0,
obtained obtainable by a process according to claim 1.

10. A carbon-supported nickel-cobalt-oxide catalyst comprising
(A) carbon in an electrically conductive polymorph, and
(B) a nickel-cobalt-oxide of formula (I):
NiₓCo₃₋ₓO₄ (I),
wherein:
x is in the range from 0.5 to 2.0. and
the catalyst is prepared by a process comprising:
evaporating solvents contained in an aqueous suspension comprising
(A) carbon in an electrically conductive polymorph,
(B1) a Ni(II) salt,
(B2) a Co(II) salt, and
(C) a chelating ligand,
to obtain a solid (S) comprising the components (A), (B1), (B2) and (C); and
calcinating the solid (S) in the presence of oxygen in a temperature range from 250° C. to 350° C.

11. A gas diffusion electrode, comprising:
the carbon-supported nickel-cobalt-oxide catalyst according to claim 9; and
a solid medium through which gas can diffuse and.

12. The gas diffusion electrode according to claim 11 which is adapted to function in an electrochemical cell.

13. An electrochemical cell, comprising a gas diffusion electrode according to claim 11.

14. The electrochemical cell according to claim 13 which is adapted to function in a rechargeable lithium-air battery.

15. A rechargeable lithium-air battery, comprising at least one electrochemical cell according to claim 13.

16. An article, comprising electrochemical cell according to claim 13, said article selected from the group consisting of a motor vehicle, a bicycle operated by an electric motor, an aircraft, a ship and a stationary energy storage device.

17. A device comprising at least one electrochemical cell according to claim 13.

18. The process according to claim 1, wherein the evaporating occurs at a temperature in the range from 20° C. to 150° C. under reduced pressure.

19. A gas diffusion electrode, comprising:
the carbon-supported nickel-cobalt-oxide catalyst according to claim 10; and
a solid medium through which gas can diffuse.

20. A gas diffusion electrode, comprising:
the carbon-supported nickel-cobalt-oxide catalyst according to claim 9; and
a solid medium through which gas can diffuse, said solid medium being a carrier for the carbon-supported nickel-cobalt-oxide catalyst.
